(19) United States
(12) Patent Application Publication
(10) Pub. No.: US 2020/0048128 A1
(43) Pub. Date: Feb. 13, 2020

(54) Method and Apparatus for Gasification Wastewater Treatment

(71) Applicant: Aquatech International, LLC, Canonsburg, PA (US)

(72) Inventors: Daniel P. BJORKLUND, Waukesha, WI (US); Gregory J. MANDIGO, DeForest, WI (US); Garry D. GLOVER, Waukesha, WI (US)

(21) Appl. No.: 16/535,811

(22) Filed: Aug. 8, 2019

Related U.S. Application Data
(60) Provisional application No. 62/716,059, filed on Aug. 8, 2018.

(51) Int. Cl. C02F 9/00; B01D 9/00; B01D 1/26; B01D 1/28

(52) U.S. Cl. CPC C02F 9/00; B01D 9/0031; C02F 2001/5218; B01D 1/26; B01D 1/28; B01D 9/0036

(57) ABSTRACT

We provide an evaporation based method for water recovery from gasification wastewater to achieve zero liquid discharge. Grey water from a gasification system is processed by an evaporation system which recovers >99% of the influent water and generates a solid phase in a crystallizing reactor. The crystallizing reactor converts dissolved solids present as highly soluble species into alternative chemical forms that are amenable to precipitation and removal from the liquid phase to achieve zero liquid discharge.

### CROSS-REFERENCE TO RELATED APPLICATIONS

This application claims benefit of U.S. Provisional Application No. 62/716,059, filed on Aug. 8, 2018, and incorporated by reference herein.

### BACKGROUND

As the coal-based power generation industry continues to evolve, there is a greater emphasis on strategies that limit or prevent the emission of harmful chemicals into the atmosphere. The coal-fired power plants that were once common are now being developed in limited quantity as future power needs will more preferably be met by clean coal technology, or through the use of other fuel sources such as natural gas and biomass, or through renewable energy forms such as solar and wind.

Gasification technology is one such technology that has been developed and applied in recent decades. In the gasification process, a carbon-bearing feedstock is converted to a mixture of hydrogen, carbon monoxide and carbon dioxide. This gas mixture is called synthesis gas (or syngas) and can be combusted as fuel for power generation. Other beneficial uses of syngas include methanol, hydrogen, hydrocarbon production, among others.

Gasifiers function by heating the carbon feedstock to very high temperatures which drives the various chemical reactions forward for the production of syngas. One of the undesirable byproducts of the gasification process is the production of “black water.” Black water contains residual carbon-based suspended solids, other colloidal particles, as well as dissolved impurities. The suspended solids present in this stream are removed and the resulting wastewater is blended with other wastewater streams from the facility and sent to a water treatment system. This stream is referred to as “grey water.”

The characteristics and composition of grey water are a function of the quality of the carbon feedstock. Various impurities present in the feedstock will be partitioned from the syngas and report to the water phase, either in the gasifier itself or in downstream gas scrubbers. Examples of these components include Arsenic, Cadmium, Chromium, Mercury, Nickel, Selenium, Cyanide, Silica, Aluminum, and Iron. The gasifier generates carbon-bearing byproducts, such as formic acid, which are also present in the grey water. Other contaminants included dissolved gases, such as hydrogen cyanide and hydrogen sulfide and boric acid, as well as the chloride salts of ammonium and sodium.

The complexity of this wastewater poses a serious challenge to conventional water treatment processes. One such example of a water treatment approach would include some or all of the following process steps:
1) removal of dissolved gases hydrogen sulfide and cyanic acid by stripping at low pH
2) pH adjustment to >11.0 for the hydroxide precipitation of heavy metals
3) removal of metal hydroxides through clarification and settling
4) dewatering of metal hydroxides with filtration or centrifugation and disposal of metal hydroxide solids in a landfill
5) removal of ammonia by stripping at high pH
6) cooling of the waste water stream
7) biological treatment for biodegradable components
8) discharge of treated wastewater into a local body of water

Prior art devices may also address each type of impurity present in grey water in a sequential process. However, such a process becomes very complex very quickly due to the quantity of individual unit operations and naturally becomes difficult to integrate and successfully operate. Additionally, this treatment approach has an inherent disadvantage of establishing the treatment goal of removing impurities to a level that satisfies the acceptable maximum concentrations suitable for discharge (as established by environmental authorities of government). Full compliance of the discharge limits becomes challenging to meet consistently over time, because as any changes to the grey water quality would increase the probability of water treatment failure. In some cases, physico chemical and biological treatment approaches were not found to be able to meet the discharge limits at all.

Reverse osmosis has also been reported as a solution to or potential solution to this challenge.
Reverse osmosis is a common method of water treatment in which a fraction of the water is recovered through a semi-permeable membrane.
RO technology requires extensive pretreatment for removal of suspended solids as well as heavy metals, and low solubility scaling salts.
RO technology is commonplace but is not ideally suited for grey water due to the high variability of the grey water which compromises the ability for the permeate water to achieve the discharge limits for constituents of concern but also compromises the lifetime of the membrane itself.

Prior art devices may use evaporation technology to recover the water fraction of the grey water for reuse within the process or elsewhere. Evaporation technology such as vertical tube falling film evaporation would have the ability to concentrate the dissolved solids present in the grey water and would achieve some fraction of water recovery. However, this technology has the disadvantage of producing a more concentrated waste stream, which would need a disposal plan (such as drying or other method). Further, the dissolved solids present in the grey water include some species that have relatively low solubility points. This would cause rapid scale formation in the evaporator and limited process availability.

A conventional evaporation approach also fails because the grey water contains dissolved solids that resist precipitation due to their high solubility. Salt species present with very high solubility points may include, for example, the following: ammonium chloride, ammonium sulfate, sodium formate, ammonium formate and calcium chloride. The presence of these species will cause the density and viscosity of the boiling solution to increase to a point where heat transfer is impaired. Further, the highly concentrated brine becomes very corrosive, requiring that the evaporator be constructed with exotic alloys such as palladium or platinum-bearing titanium and nickel-bearing austenitic steels (Hastelloy C, Inconel 625, or other).

Selection and implementation of the conventional water treatment technology for water production is limited by operating disadvantages as well as high capital costs. Engineering solutions typically address single impurities sequentially, with strippers, clarifiers, evaporators, and incinerators performing, respectively, gas removal, precipitation of heavy metals, water recovery, and elimination of water from concentrated waste products. Unfortunately, such solutions require extensive pretreatment to decrease scaling, and they cannot achieve zero liquid discharge when used alone due to the highly soluble species that are present.

### BRIEF SUMMARY OF THE INVENTION

We provide an evaporation based method for water recovery from gasification wastewater to achieve zero liquid discharge. Grey water from a gasification system is processed by an evaporation system which recovers >99% of the influent water and generates a solid phase in a crystallizing reactor. The crystallizing reactor converts dissolved solids present as highly soluble species into alternative chemical forms that are amenable to precipitation and removal from the liquid phase to achieve zero liquid discharge.

Embodiments may provide a method of achieving zero-liquid discharge from gasification wastewater including gasifying a carbon-bearing feedstock, wherein the gasifying generates a wastewater stream; sending the wastewater stream to a crystallizing reactor; feeding a first chemical into the crystallizing reactor, wherein the first chemical converts dissolved solids into forms which are configured to be more easily concentrated and/or crystallized and/or precipitated; evaporating the water fraction of the wastewater stream into water vapor; condensing the water vapor to form distillate water; precipitating the dissolved solids, wherein the precipitated solids form suspended solids; and dewatering the suspended solids for disposal.

In some embodiments the first chemical is limestone or hydrated lime. In some embodiments a mixed salt consisting essentially of calcium formate is precipitated and dewatered. In further embodiments the first chemical converts the dissolved solids to forms having lower solubility points than the dissolved solids and/or to forms more easily precipitated from the aqueous phase than the dissolved solids. Still further embodiments include feeding the wastewater stream to a chemical reactor upstream from the crystallizing reactor, wherein a second chemical is added for water conditioning upstream of the crystallizing reactor.

Some embodiments further provide feeding the wastewater stream to an external stripping column, wherein a gas phase is introduced at the bottom of the column, and wherein the gas phase flows countercurrent to the wastewater stream and removes dissolved gases. In some embodiments the wastewater stream is preheated by exchanging heat with the distillate water.

In some embodiments the evaporating step utilizes forced-circulation evaporation. In some embodiments the evaporating step utilizes multiple-effect evaporation. In some embodiments the evaporating step is driven by a steam source or steam with thermal vapor compression, mechanical vapor compression or by a combination of vapor compression and an external steam source. In a further embodiment the precipitated dissolved solids are dewatered with a centrifuge, filtration device or other solid-liquid phase separator technology.

In a still further embodiment the first chemical adjusts the pH of the wastewater stream. Further embodiments may include a water treatment step upstream of the crystallizing reactor, wherein the water treatment step further reduces the concentration of dissolved solids in the wastewater stream. In a further embodiment the water treatment step is ultrafiltration, nanofiltration or ion exchange. In a still further embodiment the water treatment step is a clarification/sedimentation process.

In a further embodiment a slip stream is taken from the distillate water and the slip stream is recycled to the gasifying step. In a yet still further embodiment a slip stream is taken from the crystallizing reactor and the slip stream is blended with carbon ash for removal of the carbon ash. In a further embodiment the evaporating step is driven by a heat source, and wherein the heat source comprises a hot fluid. In a still further embodiment the crystallizing reactor is operated under a vacuum to further decrease the solubility of the dissolved solids. In a yet still further embodiment the wastewater stream is fed to an upstream stripping column, wherein the stripping column operates at a basic pH, and wherein ammonia is removed before sending the wastewater stream to the crystallizing reactor.

### BRIEF DESCRIPTION OF THE DRAWINGS

FIG. 1: Conventional Technology: Gasification with treated water for discharge.

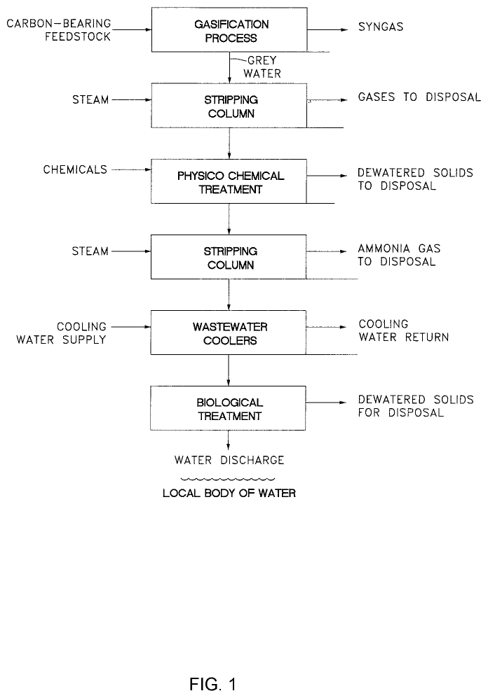

FIG. 2: Conventional Technology: Gasification with partial evaporation and concentrated brine discharge.

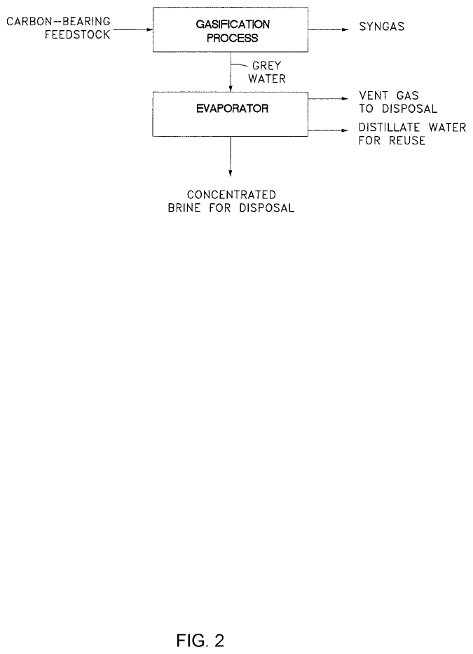

FIG. 3: Technology Claimed: Gasification with Crystallizing Reactor for zero-liquid discharge.

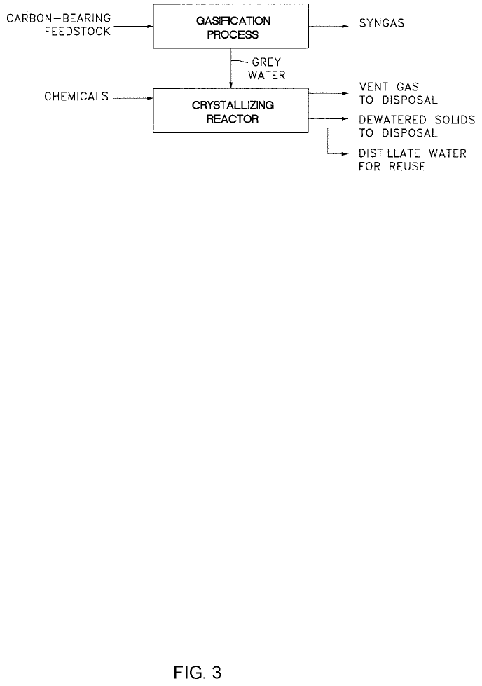

FIG. 4: Crystallizing Reactor with Steam-Driven Evaporation

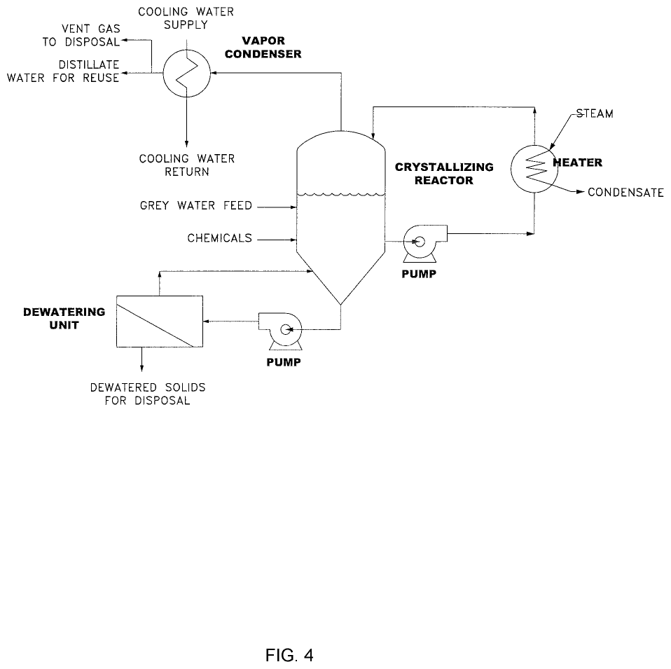

FIG. 5: Crystallizing Reactor with Mechanical Vapor Compression Evaporation

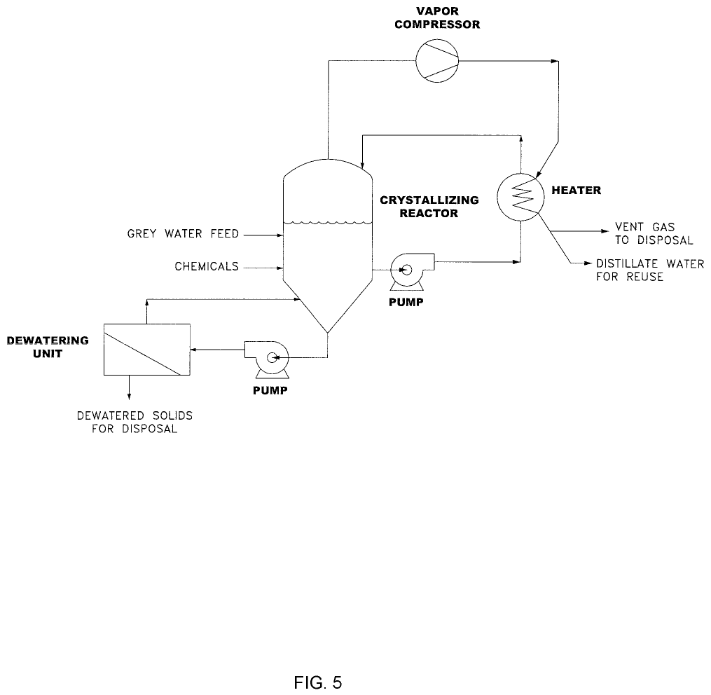

FIG. 6: Example: Grey Water conditioning upstream of the Crystallizing Reactor for removal of dissolved gases and chemical reaction upstream.

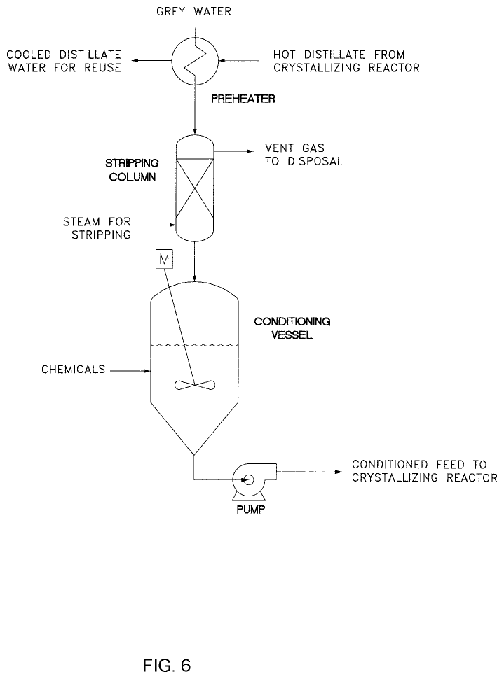

### DETAILED DESCRIPTION

Embodiments as reported herein include a crystallizing reactor that modifies the primary dissolved components into a form which is conditioned and amenable to concentration and precipitation. Salt forms that would otherwise be very highly soluble and resistant to concentration are converted into a form that can readily be precipitated at low to moderate concentration and subsequently dewatered to achieve zero-liquid discharge.

We expect that embodiments of this new process may, but are not required to yield one or more of the following benefits for the technology compared to the conventional processes:
Zero-liquid discharge is achieved, which eliminates wastewater discharge and the corresponding danger of constituents of concern entering local bodies of water. The influent dissolved solids are ultimately converted to a suspended solid and dewatered for solids disposal in a landfill.
Cleaning frequency of equipment is significantly reduced since the evaporation process is substantially non-scaling; that is, a crystallizing reactor is typically designed for chemical reaction and precipitation and does not experience scaling like a conventional evaporator.
Conversion of dissolved solids to low solubility salts allows the process to operate reliably and with high availability.
Heat transfer is done very efficiently by limiting the viscosity of the solution by eliminating the highly soluble salt species.

Another design feature of the process is the ability to reduce the corrosion potential by modifying the operating chemistry. This can be done, in one embodiment, by adding chemicals such as Ca(OH)₂ to maintain a pH greater than 11.0. In some embodiments the pH is between 10-12. In other embodiments the pH is between 10.5 and 11.5. In further embodiments a suitable chemical is sodium hydroxide or strontium hydroxide. In typical embodiments the added chemical is hydrated lime or caustic soda. This mode of operation would allow the evaporation process to be constructed with leaner metal alloys (lower cost) since the corrosion potential of the process can be substantially reduced.

In one embodiment we provide a method of achieving zero-liquid discharge from gasification wastewater including the following steps. First, a carbon-bearing feedstock is gasified in a process that generates a wastewater stream. Following gasification, the wastewater stream is sent to a crystallizing reactor in which a chemical is fed to the reactor to convert the dissolved solids into forms with substantially lower solubility points. The water fraction of the wastewater stream is converted into water vapor through evaporation. Following evaporation, the water vapor is then condensed to form distillate water that can be used beneficially within the gasification process or elsewhere. Finally, the dissolved solids fraction precipitates to form suspended solids. These are dewatered for disposal.

Each of these steps, alternatives thereto, and possible additional steps are discussed in more detail below.

A. Gasification

There are many types of gasifiers that are in commercial use today. Each gasifier technology has variations in how the carbon-bearing fuel is put into contact with the oxidant, the temperature and pressure of operation. Some technologies have fixed-beds, with either co-current or counter-current flow. Others use fluidized beds or entrained flow. Oxidants include air, oxygen-enriched air, oxygen or steam.

Multiple carbon bearing feedstocks are suitable for use in embodiments of the invention. These include, for example, but are not limited to coal, petroleum-coke, petroleum, naptha, fuel oil, asphalt and natural gas. Biomass and bio-waste sources may also be used for gasification.

These include but are not limited to grass, crop-residue, wood chips, bark, and saw mill coproduct.

Depending on the type of gasification technology that is employed, including definition of the other variables described above, the resulting grey water will have varying characteristics. The grey water can contain suspended solids, ammoniacal nitrogen (ammonia and ammonium), dissolved salts such as ammonium chloride, ammonium sulfate, sodium formate, ammonium formate and calcium chloride as well as silica. Other common contaminants include arsenic, cadmium, chromium, mercury, nickel, selenium, aluminum, iron and cyanide.

B. Crystallization

The crystallizing reactor may be, for example, the main-body of a crystallizer in which residence time, temperature and circulation are maintained to induce chemical change. As previously noted, the crystallizing reactor typically includes a chemical feed that converts dissolved solids in the grey water into forms with lower solubility points which are amenable to concentration in solution, crystallization and phase removal. The primary constituent present in the grey water may be, for example, formate. The chemical feed may be, for example, limestone or hydrated lime.

Use of compounds with lower solubility points relative to the original form of the impurities allows the compounds to be more readily precipitated from the aqueous phase. This conversion may take place through addition of chemicals that adjust the pH in the solution. Typically pH is increased. In some embodiments pH is increased to greater than 9.0, greater than 10.0, or greater than 11.0.

A common example of the highly soluble species present in the grey water is the formate ion. In the presence of sodium, sodium formate is soluble to 160 grams per 100 grams of water (at 100° C.). The use of limestone or hydrated lime results in precipitation of a mixed salt that is primarily calcium formate, which has a much lower solubility of approximately 18 grams per 100 grams of water (at 100° C.).

In addition to the removal of calcium formate from the solution, other components are simultaneously removed. These may include species that manifest as dissolved gases such as ammoniacal nitrogen (ammonium). These species are converted to a dissolved gas (for example, ammonia) at elevated solution pH and leaves the crystallizing reactor with the gas phase. Other examples include heavy metals such as calcium, nickel, aluminum and iron (among others) which are precipitated from solution as metal hydroxides which can be subsequently removed along with the solid phase.

The calcium formate and other precipitated species are dewatered for disposal. Other components may also be dewatered. Dewatering of the solids reduces the presence of liquid in the solid phase such that no free liquid is associated with the solid. The only remaining water content is referred to as moisture and is present interstitially. Typical moisture contents range between 5-25 wt %. Dewatering may be conducted, for example, by a centrifuge, filtration, or other solid-liquid separator.

In some embodiments, additional water conditioning is conducted in a conditioning vessel upstream of the crystallizing reactor. This water conditioning may be, for example, to allow finer control over the chemical reaction, such that the chemical reactant can be added without immediately producing a reaction which results in phase change. The crystallizing reactor induces the phase change by concentrating the conditioned feedwater which drives crystal formation and growth.

Another example of conditioning is to adjust the pH in the conditioning vessel upstream of the crystallizing reactor with a chemical, such as a strong base like caustic soda, which is not the ultimate crystallizing reactant. Such a scenario allows very fine control over the pH of the reaction prior to introduction of the reactant downstream.

In some embodiments the grey water is fed to an external stripping column prior to the crystallization step. In the stripping column a gas phase is introduced at the bottom of the column. Typically this gas phase is steam, but could also be air or other gases which could act as a carrier for the dissolved contaminant gases present in the grey water. The gas phase flows countercurrent to the grey water liquid phase and removes dissolved gases from the grey water. Gaseous stripping efficiencies typically range between 95-99% or greater. Maximizing the removal of dissolved gases upstream of the crystallizing reactor is typically beneficial. In some embodiments, the stripping column operates at an acidic pH for removal of acidic gases. Typically an “acidic pH” is a pH less than 6.0. In other embodiments the stripping column operates at a basic pH for removal of ammonia from the grey water stream prior to treatment in the crystallizing reactor. Typically a “basic pH” is a pH greater than 9.0.

In some embodiments the crystallizing reactor is operated under a vacuum. This further decreases solubility of dissolved components in the grey water. One example of a constituent which has a lower solubility under a partial vacuum condition is ammonium chloride, whose solubility decreases from 75 grams (per 100 grams of water) at 100° C. to 53 grams (per 100 grams of water) at 60° C.

Prior to crystallization the grey water may be preheated. In some embodiments the grey water is preheated by heat exchange with a distillate stream from later in the grey water treatment process.

Prior to crystallization the grey water may also be further treated to reduce concentration of solids in the grey water. This treatment may be conducted, for example, through one or more of ultrafiltration, nanofiltration, clarification, and sedimentation.

Following crystallization all or part of the concentrated grey water is sent for evaporation and condensation. When only part of the grey water is sent for evaporation and condensation, the remainder, a slip stream, may be recycled to the gasification process for recovery of additional, typically beneficial, components. In other embodiments a slip stream is blended with a further component for removal. This further component may be, for example, carbon ash, or another solid waste stream

C. Evaporation and Condensation

Multiple methods of evaporation may be suitable for use in embodiments of the invention. For example, embodiments may use forced-circulation evaporation or multiple effect evaporation Evaporation may also be driven by a source of steam, or steam in conjunction with thermal vapor compression. Mechanical vapor compression may also be used. In some processes combinations of vapor compression and an external steam source are used to help drive evaporation. In further embodiments evaporation is driven by a hot fluid heat source.

### EXAMPLES

Consider a gasification system which has a requirement for zero liquid discharge. The gasifier is fed with petroleum coke and operates in conditions such that a grey water is formed which is primarily composed of formates and chlorides. In this example, the representative grey water stream composition is shown in Table 1. The grey water is partially recycled back to the gasification process as it can be used to off-set the amount of make-up water. However, the recycle stream is limited based on the accumulation of chlorides allowable. Based on this limitation, a grey water stream is discharged on a continuous basis at a flow rate of 100 gallons per minute.

TABLE 1

| Aluminum | 20 | ppm |
|---|---|---|
| Ammonium | 2590 | ppm |
| Arsenic | 100 | ppb |
| Bicarbonate | 60 | ppm |
| Calcium | 60 | ppm |
| Chloride | 1200 | ppm |
| Chromium | 1 | ppm |
| Copper | 200 | ppb |
| Cyanide | 1 | ppm |
| Formic Acid | 5200 | ppm |
| Hydrogen Sulfide | 3 | ppm |
| Magnesium | 12 | ppm |
| Manganese | 1 | ppm |
| Mercury | 5 | ppb |
| Nickel | 50 | ppm |
| Potassium | 15 | ppm |
| Silica | 90 | ppm |
| Sodium | 32 | ppm |
| Sulfate | 240 | ppm |
| Vanadium | 4 | ppm |
| Zinc | 6 | ppm |
| COD | Present | |
| BOD | Present | |
| TDS | 9450 | ppm |
| TSS | 0.05% | w/w |

| | |
|---|---|
| pH | 7.0 |

The conventional treatment approach would involve stripping the hazardous gases from the liquid phase, physico-chemical treatment for removal of heavy metals including, cyanide, mercury, arsenic followed by biological reduction of formates/COD/BOD. Upon treating in this manner, the grey water may be made suitable for discharge. This approach has several drawbacks including not recycling any water back to the process (which increases the consumption of fresh water from local sources) and does not meet the zero liquid discharge mandate for the project.
Another conventional treatment approach is evaporation. In such an approach, the evaporator is a vertical-tube falling film type evaporator and would concentrate the grey water recovering a fraction of the water. The evaporator itself would experience up-time availability limitations associated with the frequent cleanings associated with the low solubility salts which would concentrate and scale the heat transfer surface area, requiring frequent down-time for cleanings. The concentration of the grey water itself would be limited due to the intensive parameters of the solution such as boiling point elevation, viscosity and density. As the grey water is concentrated, these parameters increase exponentially thereby limiting effective heat transfer and evaporation. Zero liquid discharge is not achieved with the evaporation approach.
The invented technology is applied to this project by treating the grey water stream to achieve ZLD. The grey water is first heated in the preheater to exchange heat with the outgoing hot distillate stream. Upon heating, the grey water is pumped to a stripping column where the hydrogen sulfide, cyanic acid and other dissolved gases are at least partially removed. The effluent from the stripping column flows to the Conditioning Vessel. The Conditioning Vessel provides residence time for the pH of the water to be increased by reacting the feed water with hydrated lime. The conditioned grey water is then sent to the Crystallizing Reactor for processing. Additional reactant hydrated lime is added directly to the crystallizing reactor. A total of 190 lb/h of hydrated lime (as CaO) is added to the process. In the Crystallizing Reactor, evaporation is induced by pumping the Reactor contents through a heater which is heated with external steam. The steam condenses and the latent energy of condensation is transferred through the heater's tubes to the circulating grey-water solution. As the heated grey-water solution returns to the Crystallizing Reactor Vessel, the concentration of dissolved solids is increased causing a chemical reaction with the lime reagent added which causes salt precipitation. The precipitated salts are pumped to a dewatering device (such as a centrifuge or belt filter press) and the solids are dewatered to a state where no free-liquid is present. The solids are then suitable for disposal while the filtered brine is recycled back to the Crystallizing Reactor to achieve ZLD.
The heater consumes approximately 12.5 tons/hr of heating steam for evaporation and 2,500 gpm of cooling water to condense the evaporated vapor. The condensed vapor forms a distillate stream at a rate of 96 gpm which is returned to the main gasifier process as make-up water. The electrical power of 350 kW is consumed for the centrifugal pumps and other rotating equipment.

Those of skill in the art will, with the benefit of this disclosure, recognize that certain variations and additions to the described technology may be made. These variations and additions should be considered within the scope and spirit of this disclosure.

We claim:

1. A method of achieving zero-liquid discharge from gasification wastewater comprising:
gasifying a carbon-bearing feedstock, wherein the gasifying generates a wastewater stream;
sending the wastewater stream to a crystallizing reactor;
feeding a first chemical into the crystallizing reactor, wherein the first chemical converts dissolved solids into forms which are configured to be more easily concentrated and/or crystallized and/or precipitated;
evaporating the water fraction of the wastewater stream into water vapor;
condensing the water vapor to form distillate water;
precipitating the dissolved solids, wherein the precipitated solids form suspended solids; and
dewatering the suspended solids for disposal.

2. The method of claim 1, wherein the first chemical is limestone or hydrated lime.

3. The method of claim 2, wherein a mixed-salt consisting essentially of calcium formate is precipitated and dewatered.

4. The method of claim 1, wherein the first chemical converts the dissolved solids to forms having lower solubility points than the dissolved solids and/or to forms more easily precipitated from the aqueous phase than the dissolved solids.

5. The method of claim 1, further comprising feeding the wastewater stream to a chemical reactor upstream from the crystallizing reactor, wherein a second chemical is added for water conditioning upstream of the crystallizing reactor.

6. The method of claim 1, further comprising feeding the wastewater stream to an external stripping column, wherein a gas phase is introduced at the bottom of the column, and wherein the gas phase flows countercurrent to the wastewater stream and removes dissolved gases.

7. The method of claim 1, wherein the wastewater stream is preheated by exchanging heat with the distillate water.

8. The method of claim 1, wherein the evaporating step utilizes forced-circulation evaporation.

9. The method of claim 1, wherein the evaporating step utilizes multiple-effect evaporation.

10. The method of claim 1, wherein the evaporating step is driven by a steam source or steam with thermal vapor compression, mechanical vapor compression or by a combination of vapor compression and an external steam source.

11. The method of claim 1, wherein the precipitated dissolved solids are dewatered with a centrifuge, filtration device or other solid-liquid phase separator technology.

12. The method of claim 1, wherein the first chemical adjusts the pH of the wastewater stream.

13. The method of claim 1, further comprising a water treatment step upstream of the crystallizing reactor, wherein the water treatment step further reduces the concentration of dissolved solids in the wastewater stream.

14. The method of claim 13, wherein the water treatment step is ultrafiltration, nanofiltration or ion exchange.

15. The method of claim 13, wherein the water treatment step is a clarification/sedimentation process.

16. The method of claim 1, wherein a slip stream is taken from the distillate water and the slip stream is recycled to the gasifying step.

17. The method of claim 1, wherein a slip stream is taken from the crystallizing reactor and the slip stream is blended with carbon ash or other solid waste product for removal of the slip stream from the process.

18. The method of claim 1, wherein the evaporating step is driven by a heat source, and wherein the heat source comprises a hot fluid.

19. The method of claim 1, wherein the crystallizing reactor is operated under a vacuum to further decrease the solubility of the dissolved solids.

20. The method of claim 1, wherein the wastewater stream is fed to an upstream stripping column, wherein the stripping column operates at a basic pH, and wherein ammonia is removed before sending the wastewater stream to the crystallizing reactor.
